(19) United States
(12) Patent Application Publication
(10) Pub. No.: US 2010/0144974 A1
(43) Pub. Date: Jun. 10, 2010

(54) POLYPROPYLENE-BASED COPOLYMER AND FILM COMPRISING THE POLYPROPYLENE-BASED COPOLYMER

(75) Inventors: Kenji IKEDA, Sodegaura-shi (JP); Shigeki Kishiro, Ichihara-shi (JP); Makoto Satoh, Chiba-shi (JP); Yasuki Fujiwara, Ichikawa-chi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku (JP)

(21) Appl. No.: 12/626,141

(22) Filed: Nov. 25, 2009

Related U.S. Application Data
(63) Continuation-in-part of application No. 12/341,049, filed on Dec. 22, 2008, now abandoned.

(30) Foreign Application Priority Data
Dec. 26, 2007 (JP) 2007-333990
Dec. 26, 2007 (JP) 2007-333994

(51) Int. Cl. C08L 23/14

(52) U.S. Cl. 525/240

(57) ABSTRACT

A polypropylene-based copolymer containing 50 to 95% by weight of a polymer component comprising 95% by weight or more of the constitutional unit derived from propylene and having a melting point exceeding 155° C. (component A) and 5 to 50% by weight of a copolymer component of propylene, ethylene and an α-olefin having 4 or more carbon atoms (component B) in which the content of the constitutional unit derived from propylene (X) is 10% by weight≦X<50% by weight, the content of the constitutional unit derived from ethylene (Y) is 50% by weight<Y≦70% by weight, the content of the constitutional unit derived from an α-olefin having 4 or more carbon atoms (Z) is 0% by weight<Z≦20% by weight, provided that the sum total of X, Y and Z is 100% by weight, and the ratio of Z to X is 1 or less.

### CROSS-REFERENCE TO RELATED APPLICATIONS

This is a Continuation-In-Part application of Ser. No. 12/341,049 filed on Dec. 22, 2008 now pending.

### BACKGROUND OF THE INVENTION

1. Field of the Invention

The present invention relates to a polypropylene-based copolymer. More particularly, the present invention relates to a polypropylene-based copolymer suitable as a material for forming a film for packaging retortable foods which is excellent in balance among heat resistance, transparency, sliding properties and low temperature impact resistance, and a film comprising the polypropylene-based copolymer.

2. Related Background Art

Since polypropylene is high in rigidity, heat resistance and packaging suitability, it is widely used in the field of materials for packaging, such as food packaging, and fiber packaging. Packaging materials are required to have such characteristics as rigidity, heat resistance, low-temperature impact resistance, heat sealing properties or blocking resistance, and are further required to have less fish eyes and to be excellent in appearance. Especially for a packaging material for retortable foods, there are demanded both heat resistance compatible with retorting sterilization in which high temperature processing is performed and impact resistance at low temperatures suitable for use at low temperatures. In order to maintain the impact resistance at low temperature, one possible approach is to incorporate a large amount of an elastomer component, but in this case, the compatibility with sliding properties is difficult to achieve.

In addition, since in recent years packaging materials for retortable foods have diversified and it is required that contents can be confirmed, films which are so high in transparency that contents can be confirmed have been used as packaging materials for retortable foods.

In Japanese Patent Application Laid-Open No. 6-93062, there is described that a film obtained from a polypropylene block copolymer having specific properties is good in appearance and is excellent in impact resistance at low temperatures, heat resistance, blocking resistance and food hygienic properties. However, with the increase of large-sized retortable pouches, a further improvement in impact resistance is demanded.

In Japanese Patent Application Laid-Open No. 8-302093, there is described an impact-resistant polypropylene-based resin composition which is excellent in transparency and comprises 95 to 10 parts by weight of a polypropylene-based resin in which less than 10% by weight of ethylene and/or an α-olefin may be copolymerized and 5 to 90 parts by weight of a copolymer elastomer containing propylene having specific physical properties, ethylene and an α-olefin as the constitutional unit, and a production method thereof. However, when the composition is extrusion processed to produce a film, the resulting film is excellent in transparency, but it may have insufficient impact resistance at low temperatures in some cases.

In Japanese Patent Application Laid-Open No. 58-71910, there is disclosed a method for producing a soft thermoplastic olefin-based block copolymer excellent in heat resistance, impact resistance, surface adhesion and scratch resistance. However, when the composition is used as a film for retortable food packaging, it may have insufficient heat resistance in some cases.

In Japanese Patent Application Laid-Open No. 59-115312, there is disclosed a method for producing a copolymer composition for a retortable film which is excellent in heat resistance and excellent in impact resistance at low temperatures, pinhole resistance, bending resistance and flexibility as well as excellent in stable heat sealing properties and food hygienic properties. However, since this composition is obtained by randomly polymerizing propylene and ethylene and/or an α-olefin having 4 to 12 carbon atoms in the first stage, it is not preferable for use as a film for high-temperature retortable food packaging in some cases.

### SUMMARY OF THE INVENTION

An object of the present invention is to provide a polypropylene-based copolymer excellent in balance among heat resistance, transparency, sliding properties and low-temperature impact resistance, and a film comprising the polypropylene-based copolymer or a polypropylene-based resin composition.

As a result of earnest studies, the present inventors have found that the present invention can solve the above problems, and have completed the present invention.

That is, the present invention relates to a polypropylene-based copolymer comprising 50 to 95% by weight of a polymer component comprising 95% by weight or more of a constitutional unit derived from propylene (component A) and having a melting point exceeding 155° C. and 5 to 50% by weight of a copolymer component of propylene, ethylene and an α-olefin having 4 or more carbon atoms (component B) in which the content of the constitutional unit derived from propylene (X) is 10% by weight≦X<50% by weight, the content of the constitutional unit derived from ethylene (Y) is 50% by weight<Y≦70% by weight, the content of the constitutional unit derived from an α-olefin having 4 or more carbon atoms (Z) is 0% by weight<Z≦20% by weight, provided that the total of X, Y and Z is 100% by weight, and the ratio of Z to X is 1 or less.

In addition, the present invention relates to a polypropylene-based copolymer comprising a polymer component comprising 95% by weight or more of a constitutional unit derived from propylene (component A) and having a melting point exceeding 155° C. and a copolymer component of propylene, ethylene and an α-olefin having 4 or more carbon atoms (component B), wherein;

(i) the content of a fraction soluble in xylene at 20° C. (CXS) of the polypropylene-based copolymer is 4-40% by weight, and
(ii) the content of the constitutional unit derived from propylene of the soluble fraction (P) is 30% by weight≦P<70% by weight, the content of the constitutional unit derived from ethylene of the soluble fraction (Q) is 30% by weight<Q≦50% by weight, the content of the constitutional unit derived from an α-olefin having 4 or more carbon atoms of the soluble fraction (R) is 0% by weight<R≦20% by weight, provided that the total of P, Q and R is 100% by weight.

### DESCRIPTION OF THE PREFERRED EMBODIMENTS

The polypropylene-based copolymer of the present invention is a polypropylene-based copolymer comprising a polymer component comprising 95% by weight or more of a constitutional unit derived from propylene and having a melting point exceeding 155° C. (component A) and a copolymer component of propylene, ethylene and an α-olefin having 4 or more carbon atoms (component B).

The content of a fraction soluble in xylene at 20° C. of the polypropylene-based copolymer is 4-40% by weight, provided that the amount of the polypropylene-based copolymer is 100% by weight. The content is preferably 5-35% by weight and more preferably 5-32% by weight. If the content of the fraction soluble in xylene at 20° C. of the polypropylene-based copolymer is less than 4% by weight, the impact resistance at low temperature may be inferior, and if the content exceeds 40% by weight, the sliding properties may deteriorate.

With regard to the ratio of the component A and the component B occupying the polypropylene-based copolymer, the content of the component A is 50 to 95% by weight, preferably 60 to 95% by weight, more preferably 60 to 90% by weight, and the content of the component B is 5 to 50% by weight, preferably 5 to 40% by weight, more preferably 10 to 40% by weight. If the content of the component B is less than 5% by weight, the impact resistance at low temperature may be inferior, and if the content of the component B exceeds 50% by weight, the sliding properties may deteriorate.

The component A is a polymer component comprising 95% by weight or more of a constitutional unit derived from propylene and having a melting point exceeding 155° C. From the viewpoint of heat resistance, the melting point of the component A is preferably higher than 158° C. and more preferably 160° C. or higher. In addition, the component A may be produced by copolymerizing propylene with ethylene and/or an α-olefin, such as 1-butene, to the extent that the melting point is not 155° C. or lower, but preferably is a propylene homopolymer. When propylene is copolymerized with ethylene and/or an α-olefin such as 1-butene, the content of the constitutional units derived from propylene is 95% by weight or more, and preferably 97% by weight or more; in other words, the content of the constitutional units derived from the monomers other than propylene in the component A is 5% by weight or less, and preferably 3% by weight or less, provided that the weight of the component A is 100% by weight. While the intrinsic viscosity of the component A is not particularly limited, it is preferably in the range of 1.5 to 3.0 dL/g, and more preferably in the range of 1.5 to 2.5 dL/g.

The content of the constitutional unit derived from propylene in the component B (X), the content of the constitutional unit derived from ethylene contained in the component B (Y), and the content of the constitutional unit derived from the α-olefin having 4 or more carbon atoms in the component B (Z) are 10% by weight≦X<50% by weight, 50% by weight<Y≦70% by weight, and 0% by weight<Z≦20% by weight, respectively, preferably 15% by weight≦X≦47% by weight, 52% by weight≦Y≦70% by weight, and 1% by weight<Z≦15% by weight, respectively, and more preferably 20% by weight≦X≦44% by weight, 55% by weight≦Y≦70% by weight, and 1% by weight≦Z≦10% by weight, respectively, provided that the sum total of X, Y, and Z is 100% by weight.

If Y is 50% by weight or less, the impact resistance may decrease, and if Y exceeds 70% by weight, the transparency may decrease. If Z is 0% by weight, the transparency may decrease, and if Z exceeds 20% by weight, the impact resistance at low temperatures may decrease.

The ratio of Z to X is 1 or less, preferably 0.7 or less, and more preferably 0.5 or less. If the ratio of Z to X is set at 1 or less, the impact resistance at low temperatures increases.

Examples of the constitutional unit derived from an α-olefin having 4 or more carbon atoms contained in the component B include constitutional units derived from 1-butene, 1-pentene, 1-hexene, 1-heptene, 1-o ctene, 4-methyl-1-pentene, vinylcyclohexane, or vinylnorbornane, and 1-butene is preferred. While the intrinsic viscosity of the component B is not particularly limited, it is preferably in the range of 2.0 to 5.0 dL/g, and more preferably in the range of 2.5 to 4.5 dL/g.

The content of the constitutional unit derived from propylene contained in the fraction soluble in xylene at 20° C. of the polypropylene-based copolymer (P), the content of the constitutional unit derived from ethylene contained in the fraction soluble in xylene at 20° C. (Q), and the content of the constitutional unit derived from an α-olefin having 4 or more carbon atoms contained in the fraction soluble in xylene at 20° C. (R) are 30% by weight≦P<70% by weight, 30% by weight<Q≦50% by weight, and 0% by weight<R≦20% by weight, respectively, preferably 34% by weight≦P≦67% by weight, 32% by weight≦Q≦50% by weight, and 1% by weight≦R≦16% by weight, respectively, and more preferably 40% by weight≦P≦64% by weight, 35% by weight≦Q≦50% by weight, and 1% by weight≦R≦10% by weight, respectively, provided that the sum total of P, Q and R is 100% by weight.

If Q is 30% by weight or less, the impact resistance may decrease, and if Q exceeds 50% by weight, the transparency may decrease. If R is 0% by weight, the transparency may decrease, and if R exceeds 20% by weight, the impact resistance at low temperatures may decrease.

While the intrinsic viscosity of the fraction soluble in xylene at 20° C. of the polypropylene-based copolymer is not particularly limited, it is preferably within the range of 1.6-4.0 dL/g, and more preferably within the range of 2.0-3.6 dL/g.

The method for producing a polypropylene-based copolymer of the present invention may be a method for producing the polypropylene-based copolymer by polymerizing monomers to produce the polymer component mainly comprising the constitutional unit derived from propylene (component A) and continuously polymerizing monomers to produce the copolymer component of propylene, ethylene and an α-olefin having 4 or more carbon atoms (component B). The polypropylene-based copolymer may be produced using a typical stereoregular catalyst by various polymerization methods.

Examples of the stereoregular catalyst include a catalyst comprising a solid titanium catalyst component, an organometal compound catalyst component and an electron donor used as needed, a catalyst system comprising a compound of a transition metal of Group IVB of the Periodic Table, the compound having a cyclopentadienyl ring and an alkylaluminoxane, or a catalyst comprising a compound of a transition metal of Group IVB of the Periodic Table, the compound having a cyclopentadienyl ring, a compound capable of reacting with the compound of a transition metal and an organoaluminum compound to form an ionic complex. Among these, preferred is the method of using a catalyst comprising a solid titanium catalyst component, an organometal compound catalyst component and an electron donor, which is further used as needed.

Examples of the solid titanium catalyst component includes, for example, a trivalent titanium compound-containing solid catalyst component which is obtained by bringing a solid catalyst component precursor obtained by reducing a titanium compound with an organomagnesium compound in the presence of a silicon compound into contact with a halogen compound (for example, titanium tetrachloride) and an electron donor (for example, an ether compound and a mixture of an ether compound and an ester compound).

Examples of the organometal compound catalyst component include organoaluminum compounds having at least one Al-carbon bond in the molecule, and trialkylaluminum, a mixture of a trialkylaluminum and a dialkylaluminum halide, or alkylalumoxanes are preferable, and triethylaluminum, triisobutylaluminum, a mixture of triethylaluminum and diethylaluminum chloride, or tetraethyldialumoxane is particularly preferable.

Examples of the electron donor compound include oxygen-containing compounds, nitrogen-containing compounds, phosphorus-containing compounds and sulfur-containing compounds. Among these, oxygen-containing compounds or nitrogen-containing compounds are preferred, oxygen-containing compounds are more preferred, and alkoxysilicons or ethers are particularly preferred.

One specific example is a catalyst system comprising (a) a trivalent titanium-containing solid catalyst component obtained by treating a solid product, which is obtained by reducing a titanium compound represented by the general formula Ti(OR₁)ₙX₄₋ₙ (R₁ represents a hydrocarbon group having 1 to 20 carbon atoms, X represents a halogen atom and n represents a number of 0<n≦4) with an organomagnesium compound in the presence of a silicon compound having a Si—O bond, with an ester compound, an ether compound and titanium tetrachloride, (b) an organoaluminum compound and (c) a silicon compound having a Si—OR₂ bond (R₂ is a hydrocarbon group having 1 to 20 carbon atoms).

Further, the organoaluminum compound is used so that the molar ratio of the Al atoms in the component (b) to the Ti atoms in the component (a) may be 1 to 200, preferably 5 to 1500, and the molar ratio of the component (c) to the Al atoms in the component (b) may be 0.02 to 500 and preferably 0.05 to 50.

The polymerization method, for example, may be carried out in either a batch system (i.e., a system in which raw materials are added to one reaction tank and subsequently reaction is conducted) or a continuous system (i.e., a system in which an apparatus comprising a plurality of reaction tanks connected one after another is used and reaction is carried out in the respective reactors successively). The polymerization method for producing a polypropylene-based copolymer of the present invention is preferably a continuous polymerization method. In addition, the polymerization method usable in the present invention includes slurry polymerization or solution polymerization, in both of which is used an inert hydrocarbon solvent, such as propane, butane, isobutane, pentane, hexane, heptane, or octane, bulk polymerization, in which a liquid olefin at the polymerization temperature is used as a medium, or vapor phase polymerization, and bulk-vapor phase polymerization in which bulk polymerization and vapor phase polymerization are performed continuously. Vapor phase polymerization is preferred. The polymerization temperature is usually in the range of −30 to 300° C. and preferably in the range of 20 to 180° C. While the polymerization pressure is not particularly limited, it is generally from atmospheric pressure to 10 MPa and preferably approximately 200 kPa to 5 MPa. Especially, it is preferable that the second process described later be a vapor phase polymerization. In order to adjust the molecular weight of a polymer to be formed, a chain transfer agent, such as hydrogen, may be added at the time of polymerization.

Polypropylene-based copolymers of the present invention can be produced by the following processes using the above-mentioned catalysts and polymerization methods.

Polymerization Process 1: A process of homopolymerizing propylene to produce a polypropylene homopolymer component (component A) or a process of copolymerizing propylene, ethylene and at least one kind of olefin selected from the group consisting of α-olefins having 4 to 10 carbon atoms to produce a polymer component mainly comprising the constitutional unit derived from propylene (component A).

Polymerization Process 2: A process of producing a copolymer component of propylene, ethylene and an α-olefin having 4 or more carbon atoms (component B) by copolymerizing propylene, ethylene and an α-olefin having 4 or more carbon atoms in the presence of the polypropylene homopolymer component or copolymer component mainly comprising the constitutional unit derived from propylene obtained in the above process 1.

The ratio of the amount of the component A to the amount of the component B can be changed by changing the period of time for polymerizing monomers to produce the component A and the period of time for polymerizing monomers to produce the component B. In addition, the composition of the component B can be changed by changing the gas composition in a mixed gas of propylene, ethylene and an α-olefin to be used when producing the component B.

Polypropylene-based copolymers of the present invention are preferably produced by a continuous polymerization method. A polypropylene-based resin composition may be produced by adding other mixing the polypropylene-based copolymer produced as mentioned above with another polymer, such as a propylene homopolymer or an ethylene-α-olefin copolymer. From the viewpoint of the balance between sliding properties and low temperature impact resistance, the content of the copolymer component of propylene, ethylene and an α-olefin having 4 or more carbon atoms (component B) in a polypropylene-based resin composition is preferably 5% by weight or more and less than 30% by weight and more preferably 10% by weight or more and less than 30% by weight based on the whole polypropylene-based resin composition. The propylene homopolymer to be added preferably fulfills the requirements of component (A), that is, the propylene homopolymer preferably has a melting point of more than 155° C.

To the polypropylene-based copolymers and the polypropylene-based resin compositions of the present invention may be added a neutralizer, an antioxidant, an ultraviolet absorber, an antistatic agent, an antifogging agent, a sliding agent, an antiblocking agent, a nucleating agent, or an organic peroxide, when needed.

The polypropylene-based copolymers and the polypropylene-based resin compositions of the present invention may be molded by a method usually used in the industry to produce molded products, e.g., extrusion forming, blow molding, injection molding, compression molding, and calendering.

The polypropylene-based copolymers and the polypropylene-based resin compositions of the present invention are used suitably for film applications by being converted into films by extrusion forming, such as T-die extrusion, and tubular extrusion. Unstretched films formed by T-die extrusion are particularly preferred. The thickness of the films is preferably 10 to 500 μm and more preferably 10 to 100 μm. The films may be subjected to surface treatment by a method usually employed in the industry, such as corona discharge treatment, flame treatment, plasma treatment, and ozone treatment.

The polypropylene-based copolymers and the polypropylene-based resin compositions of the present invention can be used suitably as films for packaging retortable foods which are to be subjected to heat treatment at high temperatures. In addition, the films can be used suitably as layers in composite films. A composite film comprises a film of the present invention and another film, such as a polypropylene biaxially stretched film, an unstretched nylon film, a stretched polyethyl terephthalate film, or an aluminum foil. The production method of a composite film includes a dry lamination method and an extrusion lamination method.

### EXAMPLES

Hereinafter, the present invention is illustrated by the following Examples and Comparative Examples, but the scope of the present invention is not limited to these Examples. In addition, the measurement values in the respective items in the detailed descriptions, Examples and Comparative Examples were measured by the following methods.

(1) Melting Point (Unit: ° C.)

After melting 10 mg of a test piece at 200° C. under a nitrogen gas atmosphere using a differential scanning calorimeter (DSC Q100, manufactured by TA Instrument Co., Ltd.), the temperature was maintained at 200° C. for 5 minutes and then was decreased to −90° C. at a temperature-decreasing rate of 10° C./min. Thereafter, the temperature was increased at a temperature-raising rate of 10° C./min, and the temperature of the maximum peak of the melting endothermic curve obtained was defined as the melting point (Tm).

(2) MFR (Unit: g/10 min)

The MFR was measured at 230° C. under a load of 2.16 kgf according to JIS K7210.

(3) Intrinsic Viscosity ([η], Unit: dL/g)

The intrinsic viscosity was measured in tetralin at 135° C. using an Ubbellohde type viscometer.

(4) Intrinsic Viscosity of Component A [η]A (Unit: dL/g)

The intrinsic viscosity [η] A of the polymer portion composed of monomers mainly comprising propylene (component A) was by taking out a polymer powder from a polymerization tank after the completion of the polymerization for producing component A and then performing the measurement by the method mentioned above (2).

(5) Intrinsic Viscosity of Component B [η]B (Unit: dL/g)

The intrinsic viscosity [η]B of the copolymer component of propylene, ethylene and an α-olefin having 4 or more carbon atoms (component B) was determined as follows.

The intrinsic viscosity [η]A of the polymer component of the monomers mainly comprising propylene (component A) and the intrinsic viscosity [η]T of the whole polypropylene-based copolymer containing the component A and the component B were measured by the method mentioned above (3), and then the intrinsic viscosity [η]B was determined by calculation from the following equation by using the polymerization ratio χ of the component B to the whole polypropylene-based copolymer (the polymerization ratio χ of the component B to the whole polypropylene-based copolymer was determined by the method described in the following (6)).

[η]B=[η]T/χ−(1/χ−1)[η]A

[η]A: The intrinsic viscosity of a polymer portion made up of monomers mainly comprising propylene (dL/g)

[η]T: The intrinsic viscosity of the whole polypropylene-based copolymer containing the component A and the component B (dL/g)

χ: The polymerization ratio of the component B to the whole polypropylene-based copolymer

(6) Polymerization Ratio of Component B to Whole Polypropylene-Based Copolymer: χ (Unit: % by weight)

In Examples 1-9 and Comparative Examples 1-4, the polymerization ratio χ of the copolymer component of propylene, ethylene and an α-olefin having 4 or more carbon atoms (component B) to the whole polypropylene-based copolymer containing the component A and the component B was calculated as follows.

χ=1−Mg(T)/Mg(P)

Mg(P): The magnesium content in a polymer taken out from the polymerization tank after the completion of the polymerization for producing the polymer portion of the monomers mainly comprising propylene (component A)

Mg(T): The magnesium content in the whole polypropylene-based copolymer containing the component A and the component B

A sample was added to a sufuric acid aqueous solution (1 mol/L) and followed by irradiation with ultrasonic waves to extract a metal component. For the resulting liquid portion, the magnesium content of the polymer was measured by IPC optical emission spectrometry.

The following formula was used for the calculation in Example 10.

χ=1−ΔH_{B}/ΔH_{A}

ΔH_{A}: The heat of fusion (J/g) of a polymer after the polymerization for producing a polymer component mainly comprising the constitutional unit derived from propylene (component A).
ΔH_{B}: The heat of fusion (J/g) of a polymer after the polymerization for producing a copolymer component of propylene, ethylene and an α-olefin having 4 or more carbon atoms (component B).

(7) Content of Constitutional Unit derived from Ethylene or 1-Butene in Component B (Unit: % by weight)

In Examples 1-9 and Comparative Examples 1-4, the content of the constitutional unit derived from ethylene in the polypropylene-based copolymer containing the component A and the component B (C2′(T)) and the content of the constitutional unit derived from 1-butene in the polypropylene-based copolymer containing the component A and the component B (C4′(T)) were determined on the basis of the description of J of Polymer Science; Part A; Polymer Chemistry, 28, 1237-1254, 1990.

In Example 10, the content of the constitutional unit derived from ethylene in a polypropylene-based copolymer comprising component A and component B (C2′(T)) and the content of the constitutional unit derived from 1-butene in a polypropylene-based copolymer comprising component A and component B (C4′(T)) were determined by the method described in pages 616-619 of Handbook of Polymer Analysis (1995, published by Kinokuniya Shoten).

Next, the content of the constitutional unit derived from ethylene of the component B (Y) and the content of the constitutional unit derived from 1-butene of the component B (Z) were calculated from C2′(T), C4′(T) and % described in the above (5) by the following method.

Y=C2′(T)/χ×100

Z=C4′(T)/χ×100

(8) Content of fraction soluble in xylene at 20° C. of Component A (CXS(A), Unit: % by weight)

A polymer powder was taken out from the polymerization tank after the completion of the polymerization for producing the component A portion and the amount of the fraction soluble in cold xylene at 20° C. was expressed in percentage (% by weight).

(9) Content of a fraction soluble in xylene at 20° C. (CXS(T), unit: % by weight) in a polypropylene-based copolymer comprising component A and component B

To 200 mL of xylene was added 1 g of polypropylene-based copolymer, and the mixture was boiled until the polymer was dissolved completely and then cooled, and the condition was regulated at 20° C. for more than one hour. Then, the mixture was separated into a soluble fraction and an insoluble fraction by using a filter paper. The content of the soluble fraction was determined by measuring the weight of a sample obtained by removing the solvent from the filtrate.

(10) Content of the constitutional unit derived from ethylene or 1-butene in the fraction soluble in xylene at 20° C. in a polypropylene-based copolymer comprising component A and component B (Q or R, unit: % by weight)

A fraction soluble in xylene at 20° C. which was separated by the method described in (9) above was determined on the basis of the disclosures in J of Polymer Science; Part A; Polymer Chemistry, 28, 1237-1254, 1990.

(11) Transparency (Haze, Unit: %)

The transparency was measured according to JIS K7105.

(12) Static Friction Coefficient (Unit: μs) and Dynamic Friction Coefficient (Unit: μk)

By overlapping the measurement surfaces of two pieces of a film sample of MD 100 mm×50 mm under a room temperature of 23° C. and a humidity of 50% and using a weight of 79.4 g at a setting area of 40 mm×40 mm, a static friction coefficient and a dynamic friction coefficient were measured at a moving rate of 15 cm/min by a friction meter TR-2 Model (manufactured by Toyo Seiki Seisaku-sho, Ltd.).

(13) Impact Resistance (Unit: kJ/m)

After placing a film in a constant-temperature chamber set at −15° C., the impact strength of the film was measured by using a hemispherical impact head having a diameter of 15 mm by a film impact tester manufactured by Toyo Seiki Seisaku-sho, LTD.

### Example 1

### (1) Production of Polypropylene-Based Copolymer (BCPP1) (Polymerization of Component A)

An autoclave made of stainless steel and equipped with a stirrer having an inner volume of 3 liters was dried under reduced pressure, purged with argon, cooled and then vacuumized. In heptane contained in a glass charger, 4.4 mmol of triethylaluminum as the component (b), 0.44 mmol of tert-butyl-n-propyldimethoxysilane as the component (c) and 11.7 mg of the solid catalyst component described in Japanese Patent Laid-Open No. 2004-182981, Example 1 (2) as the component (a) were brought into contact with each other and thereafter they were added together to the autoclave, and further 780 g of liquefied propylene was charged. Subsequently, hydrogen was charged until the pressure inside the autoclave was increased by 0.15 MPa and then the autoclave was heated to 80° C. to start polymerization. After 10 minutes from the start of the polymerization, unreacted propylene was purged away from the polymerization system. After the atmosphere inside of the autoclave was replaced with argon, a small amount of a polymer was sampled. The polymer sampled had a melting point (Tm) of 163.8° C., an intrinsic viscosity ([η]A) of 1.77 dL/g and a content of a fraction soluble in xylene at 20° C. (CXS) of 0.6% by weight.

### (2) Production of Polypropylene-Based Copolymer (BCPP1) (Production of Component B)

Subsequently, the 3-L autoclave was depressurized and a steel cylinder having an inner volume of 24 liters connected to the 3-L autoclave was vacuumized. A mixed gas was prepared by adding 210 g of propylene, 190 g of ethylene and 80 g of 1-butene and then heating to 80° C. The mixed gas was continuously fed to the 3-L autoclave and the polymerization pressure was set at 0.8 MPa and the polymerization temperature was set at 70° C. to perform polymerization for 1.2 hours. After 1.2 hours, the gas in the autoclave was purged to terminate the polymerization and the resulting polymer was dried under reduced pressure at 60° C. for 5 hours to obtain 260 g of a polymerized powder, which was named BCPP1. The resulting polymer had an intrinsic viscosity ([η]T) of 2.68 dL/g. As a result of analysis, the content of a ethylene-propylene-butene copolymer portion (component B) was 37% by weight. Therefore, the polymer produced in the latter stage (component B) had an intrinsic viscosity ([η]B) of 4.24 dL/g. In addition, the ethylene content in the component B was 59% by weight, and the 1-butene content in the component B was 8% by weight. The polymerization conditions are shown in Table 1 and the analytical results of the resulting polymer are shown in Table 2.

### (3) Production of Film and Its Physical Properties

To 194.4 g of a polypropylene-based copolymer (BCPP1) and 255.6 g of a propylene homopolymer having a [η] of 1.57 and a Tm of 162.1° C. were added 0.05 parts by weight of calcium stearate, 0.20 parts by weight of Irganox 1010 (produced by Ciba Specialty Chemicals) and 0.05 parts by weight of Irgafos 168 (produced by Ciba Specialty Chemicals) as stabilizers, followed by melt-kneading the mixture at 250° C. using a single screw extruder having a diameter of 20 mm (VS20-14 Type, equipped with a full-flight type screw, manufactured by Tanabe Plastics Machinery Co, Ltd., L/D=12.6) to obtain a polypropylene-based resin composition having an MFR of 4.1 g/10 min.

The resulting polypropylene-based resin composition was melt-extruded at a resin temperature of 280° C. using a T-die film forming machine having a diameter of 20 mm (VS20-14 Type, equipped with a T-die having a width of 100 mm, manufactured by Tanabe Plastics Machinery Co, Ltd.). The melt-extruded product was cooled with a cooling roll in which cooling water at 30° C. was passed, thereby obtaining a film having a thickness of 30 μm. The physical properties of the resulting film are shown in Table 4.

### Example 2

### (1) Production of Polypropylene-Based Copolymer (BCPP2)

Polymerization was carried out in the same manner as in Example 1 except for using 13.0 mg of the component (a), using a gas prepared by adding 240 g of propylene, 190 g of ethylene and 40 g of 1-butene as a mixed gas in the polymerization for producing the component B, and changing the polymerization time to 1.0 hour. The polymerization conditions are shown in Table 1 and the analytical results of the resulting polymer are shown in Table 2. The resulting propylene-based copolymer was named BCPP2.

### (2) Production of Film and Its Physical Properties

Except that 250.2 g of BCPP2 was used as a polypropylene-based copolymer and 199.8 g of a propylene homopolymer having a [η] of 1.57 and a Tm of 163.5° C. was added, a polypropylene-based resin composition having an MFR of 3.8 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Example 3

### (1) Production of Polypropylene-Based Copolymer (BCPP3)

Polymerization was carried out in the same manner as in Example 1 except for using 9.4 mg of the component (a), using a gas prepared by adding 200 g of propylene, 170 g of ethylene and 150 g of 1-butene as a mixed gas in the polymerization for producing the component B, and changing the polymerization time to 1.0 hour. The polymerization conditions are shown in Table 1 and the analytical results of the resulting polymer are shown in Table 2. The resulting propylene-based copolymer was named BCPP3.

### (2) Production of Film and Its Physical Properties

Except that 128.7 g of BCPP3 was used as a polypropylene-based copolymer and 171.3 g of a propylene homopolymer having a [η] of 1.57 and a Tm of 163.5° C. was added, a polypropylene-based resin composition having an MFR of 3.8 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Example 4

### (1) Production of Polypropylene-Based Copolymer (BCPP4)

Polymerization was carried out in the same manner as in Example 1 except for using 11.1 mg of the component (a), using a gas prepared by adding 250 g of propylene, 190 g of ethylene and 30 g of 1-butene as a mixed gas in the polymerization for producing the component B, and changing the polymerization time to 1.1 hours. The polymerization conditions are shown in Table 1 and the analytical results of the resulting polymer are shown in Table 2. The resulting propylene-based copolymer was named BCPP4.

### (2) Production of Film and Its Physical Properties

Except that 222.4 g of BCPP4 was used as a polypropylene-based copolymer and 177.6 g of a propylene homopolymer having a [η] of 1.57 and a Tm of 163.5° C. was added, a polypropylene-based resin composition having an MFR of 3.8 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Example 5

### (1) Production of Polypropylene-Based Copolymer (BCPP5)

Polymerization was carried out in the same manner as in Example 1 except for using 9.2 mg of the component (a), using a gas prepared by adding 260 g of propylene, 190 g of ethylene and 20 g of 1-butene as a mixed gas in the polymerization for producing the component B, and changing the polymerization time to 0.9 hour. The polymerization conditions are shown in Table 1 and the analytical results of the resulting polymer are shown in Table 2. The resulting propylene-based copolymer was named BCPP5.

### (2) Production of Film and Its Physical Properties

Except that 231.6 g of BCPP5 was used as a polypropylene-based copolymer and 168.4 g of a propylene homopolymer having a [η] of 1.57 and a Tm of 163.5° C. was added, a polypropylene-based resin composition having an MFR of 4.6 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Example 6

### (1) Production of Polypropylene-Based Copolymer (BCPP6)

Polymerization was carried out in the same manner as in Example 1 except for using 11.1 mg of the component (a), using a gas prepared by adding 170 g of propylene, 220 g of ethylene and 80 g of 1-butene as a mixed gas in the polymerization for producing the component B, and changing the polymerization time to 0.7 hour. The polymerization conditions are shown in Table 1 and the analytical results of the resulting polymer are shown in Table 2. The resulting propylene-based copolymer was named BCPP6.

### (2) Production of Film and Its Physical Properties

Except that 238.5 g of BCPP6 was used as a polypropylene-based copolymer and 211.5 g of a propylene homopolymer having a [η] of 1.57 and a Tm of 163.5° C. was added, a polypropylene-based resin composition having an MFR of 3.5 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 1

### (1) Production of Polypropylene-Based Copolymer (BCPP7)

Polymerization was carried out in the same manner as in Example 1 except for using 8.8 mg of the component (a), using a gas prepared by adding 340 g of propylene and 140 g of ethylene as a mixed gas in the polymerization for producing the component B, and changing the polymerization time to 0.7 hour. The polymerization conditions are shown in Table 1 and the analytical results of the resulting polymer are shown in Table 2. The resulting propylene-based copolymer was named BCPP7.

### (2) Production of Film and Its Physical Properties

Except that 132.3 g of BCPP7 was used as a polypropylene-based copolymer and 167.7 g of a propylene homopolymer having a [η] of 1.57 and a Tm of 163.5° C. was added, a polypropylene-based resin composition having an MFR of 4.2 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 2

### (1) Production of Polypropylene-Based Copolymer (BCPP8)

Polymerization was carried out in the same manner as in Example 1 except for using 10.9 mg of the component (a), using a gas prepared by adding 260 g of propylene, 110 g of ethylene and 170 g of 1-butene as a mixed gas in the polymerization for producing the component B, and changing the polymerization time to 2.0 hours. The polymerization conditions are shown in Table 1 and the analytical results of the resulting polymer are shown in Table 2. The resulting propylene-based copolymer was named BCPP8.

### (2) Production of Film and Its Physical Properties

Except that 231.8 g of BCPP8 was used as a polypropylene-based copolymer and 218.2 g of a propylene homopolymer having a [η] of 1.57 and a Tm of 163.5° C. was added, a polypropylene-based resin composition having an MFR of 4.4 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 3

### (1) Production of Polypropylene-Based Copolymer (BCPP9)

Polymerization was carried out in the same manner as in Example 1 except for using 12.0 mg of the component (a), using a gas prepared by adding 160 g of propylene, 150 g of ethylene and 230 g of 1-butene as a mixed gas in the polymerization for producing the component B, and changing the polymerization time to 1.2 hour. The polymerization conditions are shown in Table 1 and the analytical results of the resulting polymer are shown in Table 2. The resulting propylene-based copolymer was named BCPP9.

### (2) Production of Film and Its Physical Properties

Except that 225 g of BCPP9 was used as a polypropylene-based copolymer and 225 g of a propylene homopolymer having a [η] of 1.57 and a Tm of 163.5° C. was added, a polypropylene-based resin composition having an MFR of 4.0 g/10 min in the same manner as in Example 1.

The resulting polypropylene-based resin composition was extrusion processed in the same manner as in Example 1, thereby obtaining a film. The physical properties of the resulting film are shown in Table 4.

### Example 7

### (1) Production of Polypropylene-Based Copolymer (BCPP10) (Production of Component A)

An autoclave made of stainless steel and equipped with a stirrer having an inner volume of 3 liters was dried under reduced pressure, purged with argon, cooled and then vacuumized. In heptane contained in a glass charger, 4.4 mmol of triethylaluminum as the component (b), 0.44 mmol of tert-butyl-n-propyldimethoxysilane as the component (c) and 12.9 mg of the solid catalyst component described in Japanese Patent Laid-Open No. 2004-182981, Example 1 (2) as the component (a) were brought into contact with each other and thereafter they were added together to the autoclave, and further 780 g of liquefied propylene was charged. Subsequently, 4 g of ethylene was charged and hydrogen was charged until the pressure inside the autoclave was increased by 0.15 MPa and then the autoclave was heated to 80° C. to start polymerization. After 10 minutes from the start of the polymerization, unreacted propylene was purged away from the polymerization system. After the atmosphere inside of the autoclave was replaced with argon, a small amount of a polymer was sampled. The polymer sampled had a melting point (Tm) of 158.9° C., an intrinsic viscosity ([η]P) of 1.91 dL/g, a content of a fraction soluble in xylene at 20° C. (CXS) of 0.9% by weight, and ethylene content of 0.6% by weight.

### (2) Production of Polypropylene-Based Copolymer (BCPP10) (Production of Component B)

Polymerization was carried out in the same manner as in Example 1 except for using a gas prepared by adding 210 g of propylene, 210 g of ethylene and 40 g of 1-butene as a mixed gas in the polymerization for producing the component B, and changing the polymerization time to 0.8 hour. The polymerization conditions are shown in Table 1 and the analytical results of the resulting polymer, which was named BCPP10, are shown in Table 2.

### (3) Production of Film and Its Physical Properties

Except that 279 g of BCPP10 was used as a polypropylene-based copolymer and 171 g of a propylene homopolymer having a [η] of 1.57 and a Tm of 163.5° C. was added, a polypropylene-based resin composition having an MFR of 3.0 g/10 min was obtained in the same manner as in Example 1.

The resulting polypropylene-based resin composition was extrusion processed in the same manner as in Example 1, thereby obtaining a film. The physical properties of the resulting film are shown in Table 4.

### Example 8

### (1) Production of Polypropylene-Based Copolymer (BCPP11)

Polymerization was carried out in the same manner as in Example 1 except for using 12.3 mg of the component (a), using a gas prepared by adding 110 g of propylene and 220 g of ethylene and 150 g of 1-butene as a mixed gas in the polymerization for producing the component B, and changing the polymerization time to 0.4 hour. The polymerization conditions are shown in Table 1 and the analytical results of the resulting polymer are shown in Table 2.

Polymerization was carried out in the same manner as above, and the resulting two polymers were mixed and the mixture, which was named BCPP11, was used in following (2).

### (2) Production of Film and Its Physical Properties

Except that 420 g of BCPP11 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Example 9

### (1) Production of Polypropylene-Based Copolymer (BCPP12)

Polymerization was carried out in the same manner as in Example 1 except for using 10.5 mg of the component (a), using a gas prepared by adding 60 g of propylene and 200 g of ethylene and 260 g of 1-butene as a mixed gas in the polymerization for producing the component B, and changing the polymerization time to 0.4 hour. The polymerization conditions are shown in Table 1 and the analytical results of the resulting polymer are shown in Table 2.

Polymerization was carried out in the same manner as above, and the resulting two polymers were mixed and the mixture, which was named BCPP12, was are used in following (2).

### (2) Production of Film and Its Physical Properties

Except that 380 g of BCPP12 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Comparative Example 4

### (1) Production of Polypropylene-Based Copolymer (BCPP13)

Polymerization was carried out in the same manner as in Example 1 except for using 11.0 mg of the component (a), using a gas prepared by adding 120 g of propylene and 250 g of ethylene and 80 g of 1-butene as a mixed gas in the polymerization for producing the component B, and changing the polymerization time to 0.3 hour. The polymerization conditions are shown in Table 1 and the analytical results of the resulting polymer are shown in Table 2.

Polymerization was carried out in the same manner as above, and the resulting two polymers were mixed and the mixture, which was named BCPP13, was used in following (2).

### (2) Production of Film and Its Physical Properties

Except that 340 g of BCPP13 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Example 10

### (1) Production of polypropylene-based copolymer (BCPP14)

### [Preparation of Solid Catalyst Component]

After displacing the atmosphere in the SUS reaction container equipped with a stirrer having an inner volume of 200 L with nitrogen, 80 L of hexane, 6.55 mole of titanium tetrabutoxide, 2.8 mole of diisobutyl phthalate, and 98.9 mole of tetraethoxysilane were added to make a homogeneous solution. Then, 51 L of diisobutyl ether solution of 2.1 mole/L of butylmagnesium chloride were added by dripping gradually over 5 hours, while maintaining the temperature inside the reaction container at 5° C. After the dripping finished, stirring was performed for an hour at room temperature and after solid-liquid separation was performed at room temperature, washing of the resulting solid with 70 L of toluene was performed three times. Then, after toluene was added to the solid so that the slurry concentration would become 0.2 kg/L, 47.6 mole of diisobutyl phthalate was added and a reaction was performed at 95° C. for 30 minutes. After the reaction, solid-liquid separation was performed and washing of the resulting solid with toluene was performed two times. Then, 3.13 mole of diisobutyl phthalate, 8.9 mole of butyl ether and 274 mole of titanium(IV) chloride were added to the solid and a reaction was performed at 105° C. for three hours. After the reaction, solid-liquid separation was performed at the same temperature and washing of the resulting solid with 90 L of toluene was performed two times at the same temperature. Then, after the slurry concentration was regulated to be 0.4 kg/L, 8.9 mole of butyl ether and 137 mole of titanium(IV) chloride were added, and a reaction was performed at 105° C. for an hour. After the reaction, solid-liquid separation was performed at the same temperature and washing of the resulting solid with 90 L of toluene was performed six times at the same temperature and further washing was performed with 70 L of hexane three times, reduced-pressure drying was performed and 11.4 kg of a solid catalyst component was obtained.

### [Preliminary Polymerization]

A preliminary polymerization was performed by adding 1.5 L of sufficiently dehydrated and degassed n-hexan, 30 mmol of triethylammonium, 3.0 mmol of cyclohexylethyldimethoxysilane, and 16 g of the solid catalyst component above to a SUS autoclave with a 3 L inner volume, and continuously supplying 32 g of propylene over 40 minutes while maintaining the temperature inside the autoclave at 3-10° C. Then the preliminary polymerization slurry was transferred to a 200-L SUS autoclave equipped with a stirrer, 132 L of liquid butane was added and a slurry of preliminary polymerization catalyst component was obtained.

Production of Component A

[Polymerization process (1)]

A vessel type reactor equipped with a stirrer having inner volume of 40 L was used. Propylene, hydrogen, triethylaluminum, cyclohexylethyldimethoxysilane, and a slurry of the preliminary polymerization catalyst component was continuously supplied, the polymerization temperature was set at 78° C., the stirring speed was set at 150 rpm, the fluid level in the reactor was maintained at 18 L, the supply amount of propylene was set at 25 kg/hr, the supply rate of hydrogen was 19 NL/hr, the supply rate of triethylaluminum was set at 41 mmol/hr, the supply rate of cyclohexylethyldimethoxysilane was set at 6.15 mmol, the supply rate of the preliminary polymerization catalyst component was set at 0.43 g/hr as expressed in the amount of the solid catalyst component and the polymerization was performed for 0.27 hours. Polymers were discharged at 2.3 kg/hr.

[Polymerization process (2)]

The polymers discharged from the reactor of polymerization process (1) was continuously transferred to a vessel-type reactor which was different from that in polymerization process (1), propylene and hydrogen was continuously supplied, the polymerization temperature was set at 73° C., the stirring speed was set at 150 rpm, the fluid level in the reactor was set at 44 L, the amount of propylene to be supplied was set at 15 kg/hr, the amount of hydrogen to be supplied was set at 10 NL/hr, and polymerization was continuously performed for 0.46 hours. The polymer was discharged at 3.4 kg/hr.

### [Polymerization Process (3)]

The polymers discharged from the reactor of polymerization process (2) was continuously transferred to a vessel-type reactor which was different from those in polymerization processes (1) and (2), the polymerization temperature was set at 68° C., the stirring speed was set at 150 rpm, the fluid level in the reactor was set at 44 L, and continuous polymerization of propylene was further performed for 0.50 hours. The polymer was discharged at 3.2 kg/hr.

### [Polymerization Process (4)]

The polymer discharged from the reactor of polymerization process (3) was continuously transferred to a fluid bed reactor equipped with a stirrer having an inner volume of 1 m³, propylene and hydrogen were continuously supplied, the polymerization temperature was set at 80° C., the polymerization pressure was set at 1.8 MPa, the concentration ratio of propylene and hydrogen in the gas inside the reactor was set at 99.04% by volume/0.96% by volume (propylene concentration/hydrogen concentration) and the polymerization was performed for 3.1 hours. The polymer component A was discharged at a rate of 7.3 kg/hr. The intrinsic viscosity [η] of the obtained polymer component (component A) was 1.73 dL/g and the content of a fraction soluble in xylene at 20° C. (CXS) was 0.3% by weight.

Production of component B

[Polymerization process (5)]

Polymer component (component A) discharged from the reactor of polymerization process (4) was continuously transferred to a fluid bed reactor equipped with a stirrer having an inner volume of 1 m³ which was different from that used in polymerization process (4), propylene, ethylene, 1-butene and hydrogen were continuously supplied, the polymerization temperature was set at 70° C., the polymerization pressure was set at 1.4 MPa, the concentration ratio of propylene, ethylene, 1-butene and hydrogen in the gas inside the reactor was set at 27.77% by volume/50% by volume/20.3% by volume/1.93% by volume (propylene concentration/ethylene concentration/1-butene concentration/hydrogen concentration), oxygen as a devitalizing agent was added in a molar ratio of 0.006 relative to the amount of the supplied triethylaluminum, and the polymerization was performed for 2.5 hours. The polymer component (component B) was discharged at 4.1 kg/hr. The intrinsic viscosity [η] of the obtained polymer component (component B) was 4.38 dL/g. The resulting polymer was named BCPP14.

The analysis result of each component of polypropylene-based copolymer is shown in Table 2.

### (2) Production of Film and its Properties

Except that 400 g of BCPP14 was used as polypropylene-based copolymer, the addition amount of propylene homopolymer having a [η] of 1.57 dL/g and a Tm of 163.5° C. was set at 100 g, and 0.02 parts by weight of 2,5-dimethyl-2,5-di(tertiary butylperoxy)hexan was added, the production was performed in the same manner as in Example 1 and polypropylene-based resin composition having an MFR of 3.5 g/10 min was obtained.

The obtained polypropylene-based resin composition was processed in the same manner as in Example 1, thereby obtaining a film. The properties of the resulting film are shown in Table 4.

TABLE 1

| | | Polymerization Conditions | | | | | |
|---|---|---|---|---|---|---|---|
| | | of Component B | | | | | Yield of |
| Examples and | Use Amount of | Mixed Gas Composition | | | | | Polypropylene-Based |
| Comparative | (a) Component | C4′ | C3′ | C2′ | Time | Pressure | Copolymer |
| Examples | mg | g | g | g | hr | MPa | g |
| Example 1 | 11.7 | 80 | 210 | 190 | 1.2 | 0.8 | 260 |
| Example 2 | 13.0 | 40 | 240 | 190 | 1.0 | 0.8 | 317 |
| Example 3 | 9.4 | 150 | 200 | 170 | 1.0 | 0.8 | 207 |
| Example 4 | 11.1 | 30 | 250 | 190 | 1.1 | 0.8 | 230 |
| Example 5 | 9.2 | 20 | 260 | 190 | 0.9 | 0.8 | 200 |
| Example 6 | 11.1 | 80 | 170 | 220 | 0.7 | 0.8 | 253 |
| Comparative | 8.8 | — | 340 | 140 | 0.7 | 0.8 | 213 |
| Example 1 | | | | | | | |
| Comparative | 10.9 | 170 | 260 | 110 | 2.0 | 0.8 | 268 |
| Example 2 | | | | | | | |
| Comparative | 12.0 | 230 | 160 | 150 | 1.2 | 0.8 | 286 |
| Example 3 | | | | | | | |
| Example 7 | 12.9 | 40 | 210 | 210 | 0.8 | 0.8 | 357 |
| Example 8 | 12.3 | 150 | 110 | 220 | 0.4 | 0.8 | 221 |
| Example 9 | 10.5 | 260 | 60 | 200 | 0.4 | 0.8 | 176 |
| Comparative | 11.0 | 80 | 120 | 250 | 0.3 | 0.8 | 190 |
| Example 4 | | | | | | | |

TABLE 2

| | | Constitution of | | | | | | |
|---|---|---|---|---|---|---|---|---|
| | Ratio of | Component A | | | Constitution of Component B | | | |
| Examples and | Component B | | CXS | | Y | X | Z | |
| Comparative | (χ) | [η] | % by | Tm | % by | % by | % by | [η] |
| Examples | % by weight | dL/g | weight | ° C. | weight | weight | weight | dL/g |
| Example 1 | 37 | 1.77 | 0.6 | 163.8 | 59 | 33 | 8 | 4.24 |
| Example 2 | 36 | 1.84 | 0.5 | 164.0 | 56 | 40 | 4 | 3.96 |
| Example 3 | 28 | 1.78 | 0.6 | 163.2 | 65 | 19 | 16 | 4.29 |
| Example 4 | 36 | 1.72 | 0.6 | 162.9 | 60 | 37 | 3 | 4.14 |
| Example 5 | 38 | 1.65 | 0.6 | 162.6 | 54 | 45 | 1 | 3.59 |
| Example 6 | 30 | 1.84 | 0.6 | 163.5 | 67 | 26 | 7 | 4.49 |
| Comparative | 29 | 1.74 | 0.6 | 162.5 | 42 | 58 | — | 3.52 |
| Example 1 | | | | | | | | |
| Comparative | 33 | 1.72 | 0.6 | 163.7 | 41 | 39 | 20 | 3.72 |
| Example 2 | | | | | | | | |
| Comparative | 32 | 1.79 | 0.5 | 163.5 | 48 | 31 | 21 | 3.36 |
| Example 3 | | | | | | | | |
| Example 7 | 26 | 1.91 | 0.9 | 158.9 | 66 | 29 | 5 | 4.53 |
| Example 8 | 23 | 1.69 | 0.6 | 164.6 | 62 | 26 | 12 | 4.12 |
| Example 9 | 25 | 1.72 | 0.6 | 163.5 | 52 | 35 | 13 | 3.93 |
| Comparative | 17 | 1.79 | 0.6 | 163.9 | 77 | 14 | 9 | 4.61 |
| Example 4 | | | | | | | | |
| Example 10 | 20 | 1.73 | 0.3 | — | 62 | 32 | 6 | 4.38 |

TABLE 3

| | Structure of CXS of Polypropylene-Based Copolymer | | | | |
|---|---|---|---|---|---|
| Examples and | CXS (T) | Q | P | R | |
| Comparative | % by | % by | % by | % by | [η] |
| Examples | weight | weight | weight | weight | dL/g |
| Example 2 | 12.3 | 41 | 55 | 4 | 2.76 |
| Example 3 | 13.8 | 40 | 44 | 16 | 2.46 |
| Comparative | 12.4 | 32 | 68 | — | 2.33 |
| Example 1 | | | | | |
| Comparative | — | 27 | 53 | 20 | 2.53 |
| Example 2 | | | | | |

TABLE 4

| Examples | | | | | | |
|---|---|---|---|---|---|---|
| and | | | | Friction | | |
| Comparative | MFR | Melting Point | Haze | Coefficient | | Impact |
| Examples | (g/10 min) | (° C.) | (%) | μs | μk | (kJ/m) |
| Example 1 | 4.1 | 163.9 | 57 | 0.79 | 0.83 | 6.0 |
| Example 2 | 3.8 | 162.9 | 59 | 0.76 | 0.80 | 9.2 |
| Example 3 | 3.8 | 163.8 | 57 | 0.87 | 0.85 | 9.8 |
| Example 4 | 3.8 | 163.1 | 62 | 0.82 | 0.81 | 8.6 |
| Example 5 | 4.6 | 163.6 | 56 | 0.88 | 0.80 | 7.2 |
| Example 6 | 3.5 | 163.6 | — | 0.86 | 0.83 | 5.9 |
| Comparative | 4.2 | 163.6 | 56 | 1.06 | 0.93 | 5.0 |
| Example 1 | | | | | | |
| Comparative | 4.4 | 163.4 | 28 | 1.01 | 1.02 | 0.9 |
| Example 2 | | | | | | |
| Comparative | 4.0 | 164.2 | — | 1.17 | 1.06 | 3.1 |
| Example 3 | | | | | | |
| Example 7 | 3.0 | 160.7 | — | 1.13 | 1.03 | 10.5 |
| Example 8 | 3.4 | 163.9 | — | 1.00 | 0.92 | 7.2 |
| Example 9 | 2.6 | 164.3 | — | 1.03 | 0.94 | 6.2 |
| Comparative | 2.7 | 164.0 | — | 1.20 | 0.99 | 4.1 |
| Example 4 | | | | | | |
| Example 10 | 3.5 | 164.2 | — | 0.83 | 0.83 | 4.5 |

The present invention can provide a polypropylene-based copolymer excellent in balance among heat resistance, transparency, sliding properties and low temperature impact resistance and a polypropylene-based resin composition containing the same, and such a copolymer and resin composition can be suitably used as a material of a film for packaging retortable foods.

What is claimed is:

1. A polypropylene-based copolymer comprising
50 to 95% by weight of a polymer component comprising 95% by weight or more of the constitutional unit derived from propylene and having a melting point exceeding 155° C. (component A) and
5 to 50% by weight of a copolymer component of propylene, ethylene and an α-olefin having 4 or more carbon atoms (component B) in which the content of the constitutional unit derived from propylene (X) is 10% by weight≦X<50% by weight, the content of the constitutional unit derived from ethylene (Y) is 50% by weight<Y≦70% by weight, the content of the constitutional unit derived from an α-olefin having 4 or more carbon atoms (Z) is 0% by weight<Z≦20% by weight, provided that the total of X, Y and Z is 100% by weight, and the ratio of Z to X is 1 or less.

2. The polypropylene-based copolymer according to claim 1, wherein the α-olefin having 4 or more carbon atoms is 1-butene.

3. A film comprising the polypropylene-based copolymer according to claim 1.

4. A polypropylene-based copolymer comprising a polymer component comprising 95% by weight or more of a constitutional unit derived from propylene and having a melting point exceeding 155° C. (component A) and a copolymer component of propylene, ethylene and an α-olefin having 4 or more carbon atoms (component B), wherein;
(i) the content of a fraction soluble in xylene at 20° C. (CXS) of the polypropylene-based copolymer is 4-40% by weight, and
(ii) the content of the constitutional unit derived from propylene of the fraction soluble in xylene (P) is 30% by weight≦P<70% by weight, the content of the constitutional unit derived from ethylene of the soluble fraction (Q) is 30% by weight<Q≦50% by weight, the content of the constitutional unit derived from an α-olefin having 4 or more carbon atoms of the soluble fraction (R) is 0% by weight<R≦120% by weight, provided that the total of P, Q and R is 100% by weight.
